(19) United States
(12) Patent Application Publication
(10) Pub. No.: US 2024/0390910 A1
(43) Pub. Date: Nov. 28, 2024

(54) Sample Holder for Use in an Analytical Method Involving Thermocycling

(71) Applicant: DIAXXO AG, Zürich (CH)

(72) Inventors: Michele Gregorini, Zürich (CH); Philippe Bechtold, Zürich (CH); Wendelin Jan Stark, Langenthal (CH)

(21) Appl. No.: 18/685,952

(22) PCT Filed: Aug. 5, 2022
(86) PCT No.: PCT/EP2022/072117

§ 371 Date: Feb. 23, 2024

(30) Foreign Application Priority Data
Aug. 24, 2021 (CH) CH070198/2021

(51) Int. Cl. B01L 3/00; B01L 7/00

(52) U.S. Cl. CPC B01L 3/50853; B01L 7/52; B01L 2200/12; B01L 2300/041; B01L 2300/12; B01L 2300/1805

(57) ABSTRACT

Disclosed herein is a sample holder for use in an analytical method involving thermocycling, such as PCR. The sample holder includes a base plate made of a base plate material. The base plate includes a top surface and an array of wells, wherein each well is configured for receiving a sample. The sample holder includes a solid cover structure being made of a material having a melting point which is lower than the melting point of the base plate material. The solid cover structure is arranged on the top surface of the base plate such that at least some of the wells are uncovered. Further disclosed are a method for manufacturing a sample holder, an apparatus and the use of the sample holder.

### CROSS-REFERENCE TO RELATED APPLICATIONS

This application is the United States national phase of International Application No. PCT/EP2022/072117 filed Aug. 5, 2022, and claims priority to Swiss Patent Application No. CH070198/2021 filed Aug. 24, 2021, the disclosures of each of which are hereby incorporated by reference in their entireties.

### BACKGROUND OF THE INVENTION

### Field of the Invention

The present disclosure relates to a sample holder for use in an analytical method involving thermocycling, such as polymerase chain reaction, according to the preamble of patent claims.

### Description of Related Art

The polymerase chain reaction (PCR) is utilized for the exponential amplification of one or more specific nucleic acid(s) of interest, particularly DNA. PCR makes it possible to create millions of copies of a nucleic acid sequence from a limited number of copies. In principle, a single copy of a given nucleic acid molecule suffices to generate millions of copies, although in practice typically more than one copy is required. PCR has the significant advantage that it enables reproduction with high fidelity. Typical temperatures included in the PCR thermal cycle are 94° C. for denaturing, 60° C. for primer annealing and 72° C. for primer elongation and double strand formation.

One challenge with PCR analysis is that it is prone to competitive side reactions, especially when performed at low temperatures, such as <60° C. Competitive side reactions include primer dimer formation or binding of a primer to a non-complementary strand.

Another challenge of performing PCR methods is evaporation from the PCR sample mixture during thermal cycling, which results in erroneous measurements, may lead to false negative measurements and may prevent detection of any targets altogether. A common attempt known from the prior art to prevent evaporation from the PCR sample mixture involves the use of a hydrophobic oils, such as mineral oil, which is layered onto the PCR reaction mixture to prevent evaporation during thermal cycling. The hydrophobic oil floats on the PCR sample mixture because it not miscible with and has a lower density than the aqueous PCR sample mixture. The hydrophobic material covers the surface of the PCR sample mixture and thus prevents water and other components of the PCR sample mixture from evaporating. Although certain sample holders, devices, methods, tools, etc. have been developed to address the pertinent problem of partial or complete evaporation from the sample mixture, they all suffer from a range of disadvantages:

The known sample holders, devices, methods, tools, etc. are still insufficient to prevent partial or complete evaporation of the sample mixture, especially if the sample volumes are small (e.g. lower than 5 μL). In particular, the use of a mineral oil layer is practically insufficient to prevent at least full, let alone partial evaporation. Mineral oil layers typically create a phase barrier and/or a vapor barrier. A further drawback associated with the use of a mineral oil layer is that it leads to an increase in the total volume per sample, thus requiring larger wells or reaction tubes, which limits the total number of samples that can be accommodated within a given volume of a sample holder.

A further disadvantage is that improper loading of the mineral oil (or any other additional device or material employed for the purposes of preventing evaporation of the sample mixture) may cause splattering of the sample mixture from its reaction receptive. Therefore, high care must be taken upon sample preparation, which makes the sample preparation tedious.

Some of the known sample holders and devices rely on a mechanism that adds complexity to the analytical method and may only be used for specific PCR machines. As an example, the use of PCR tubes with plastic lids require heating of the lid to prevent condensation of water. Use of these PCR tubes is thus limited to PCR machines accommodating a heating element to heat the lids. Furthermore, some known methods to prevent evaporation of the sample mixture require additional steps, such as centrifugation steps, which are time-consuming and reduce output capacity.

The known sample holders, devices, methods, tools, etc. further suffer from severe limitations in the heat transfer rates, thus limiting the number of cycles that can be run per minute. These limitations in heating and cooling capability eventually translate to a limited analysis output.

The known sample holders, devices, methods, tools, etc. have severely limited capabilities to decrease the risk of contaminations. Even small amounts of contaminations, including, in the most extreme case, single molecules, can have an impact on the experimental results of a PCR analysis. This is in part due to the exponential nature of this type of analysis that generates trillions of replicates of the initial template. It follows that the limited capabilities to decrease the risk of contaminations is a particularly severe limitation in the area of PCR analysis.

A further drawback of most known sample holders, devices, methods, tools, etc. is that they are typically limited to one particular type of analytical method involving thermocycling, frequently PCR analysis. As an example, depending on the type of analytical method involving thermocycling, the temperature ranges and the frequency of thermocycling may be vastly different. However, e.g. the use of an additional mineral oil layer is typically tailored to the specific parameters of a single type of analytical method and cannot be applied to other analytical methods involving thermocycling without arduous adaption of its parameters.

### SUMMARY OF THE INVENTION

It is therefore the general objective of the present invention to advance the state of the art with respect to analytical methods involving thermocycling, particularly PCR analysis. In advantageous embodiments, the disadvantages of the prior art are overcome fully or partly. In advantageous embodiments, a sample holder is provided which at least partially, preferably fully, prevents evaporation of the sample mixture, such as the PCR sample mixture. In further advantageous embodiments, a sample holder is provided, which allows for a reduced contamination risk and/or allows for fast and easier sample preparation. In further advantageous embodiments, a sample holder with a high heating and cooling capability is provided, which enables a high rate of thermocycling, i.e. a large number of thermocycles that can be run per unit of time.

The general objective is solved by the subject-matter and advantageous embodiments disclosed herein.

In a first aspect, the general objective is achieved by a sample holder for use in an analytical method involving thermocycling, such as polymerase chain reaction (PCR). The sample holder comprises a base plate, wherein the base plate is made of a base plate material. The base plate comprises a top surface. Hereinafter, the top surface of the base plate is also labelled the base plate top surface. Furthermore, the base plate comprises an array of wells, wherein each well is configured for receiving a sample. The sample holder further comprises a solid cover structure being made of a material having a melting point which is lower than the melting point of the base plate material. The solid cover structure is arranged on the base plate top surface such that at least some of the wells are uncovered.

When performing an analytical method involving thermocycling using the sample holder disclosed herein, the solid cover structure will melt during heating and thus flow towards the wells that were previously uncovered. As a result, during or after heating, at least some, preferably all, of the previously uncovered wells will eventually be covered by the molten cover structure. This prevents at least full, preferably even partial, evaporation of the sample. It is understood that the term “solid cover structure” refers to a cover structure that is in the solid form. Upon application of heat, the cover structure may melt and thus be a “molten cover structure”.

In typical embodiments, the solid cover structure is configured to be molten upon heat application and to cover the well openings. Furthermore, the solid cover structure may be made from a water immiscible material and/or a material with a lower density than water.

An analytical method involving thermocycling is an analytical method during which at least two different temperatures T1 and T2 for at least two different time periods are applied. In some embodiments, the sample to be analyzed and/or the sample holder is exposed to the at least two different temperatures T1 and T2. As an example, the analytical method may involve consecutively setting temperature T1 for a first period p1, following by setting temperature T2 for a second period p2, followed again by T1 for the period p1, followed again by T2 for the period p2, and so on. In some embodiments, the sample holder for use in an analytical method involving thermocycling is a sample holder for use in polymerase chain reaction.

As the skilled person understands, the wells are typically blind holes. These blind holes are preferably open towards the base plate top surface. In some embodiments, the base plate comprises at least 1 well, particularly at least 4 wells, more particularly at least 10 wells, more particularly at least 20 wells.

In some embodiments, at least some of the wells are uncovered by the solid cover material. In certain embodiments, all of the wells are uncovered, particularly uncovered by the solid cover material. Uncovered means that the uncovered wells are accessible and/or in direct fluid communication with the outside environment, such as accessible for introducing a sample to be analyzed, e.g. using a pipette or a sample distribution device. In further embodiments, some of the wells are uncovered by the solid cover material and the remainder of the wells are covered by the solid cover material. These embodiments may, for example, be used if those wells that are covered by the solid cover material are not intended to be filled with sample.

The solid cover structure is a cover structure made of a material that is solid, particularly solid at ambient temperature and pressure (1 atm), such as at −30° C. to 35° C., e.g. 15° C. to 35° C. In particular, solid cover structures include malleable cover structures. A malleable cover structure is a cover structure that is amenable to mechanical working, such as being extended, beaten, hammered, pressed or punctured into a shape, without breaking, particularly without breaking and cracking. In particular, the material of which the solid cover structure is made up includes wax, such as malleable wax.

In some embodiments, the meting point of the solid cover structure is below 100° C., particularly below 80° C., particularly below 60° C., particularly below 50° C.

In some embodiments, the melting point of the solid cover structure is 38° C.-55° C., particularly 40° C.-44° C. more particularly 42° C. As the skilled person understands, the melting point refers to the meting point at ambient pressure, i.e. at 1 atm.

The material of the solid cover structure is preferably chosen such that its melting point is lower than the highest, particularly lower than the lowest, temperature that may be set during the corresponding method involving thermocycling. As an example, for PCR analysis involving thermocycling between 38° C. and 99° C., the material of the solid cover structure is preferably chosen such that its melting point is 38° C.-48° C., such as 40° C.-44° C.

In some embodiments, the solid cover structure is made of wax.

Wax, as used herein, refers to a class of compounds, in particular organic compounds, that are malleable solids at temperature between −30° C. to 35° C., e.g. 15° C. to 35° C. The compounds are preferably lipophilic. Wax includes lipids and higher alkanes. In some embodiments, wax has a melting point above 35° C., such as above 38° C., particularly above 40° C. In specific embodiments, wax includes paraffin wax, particularly paraffin wax comprising a mixture of C₂₀-C₄₀ hydrocarbon molecules. The skilled person further understands that different solid cover structure materials, in particular different types of waxes may be used. As an example, waxes that are based on higher alkanes may be used as well as waxed based on lipids or waxes based on other compound classes or any mixture of these compounds classes.

One advantage of using wax, particularly the above-mentioned types of wax, as solid cover structure is that they are particularly well-suited for use in PCR analysis. The typical temperature profiles employed in PCR analysis allow for efficient and rapid melting of the wax. In particular, at the typical temperatures employed during PCR, such as 55-98° C., the wax is in a molten state and has a viscosity and flowability that allow it to efficiently and rapidly flow laterally such that it covers the previously uncovered wells within a reasonable amount of time. In particular, no additional external driving force, such as mechanical stirring, shaking or pressing are necessary to enhance the flow of the wax. Rather, the wax flows rapidly enough to ensure that all previously uncovered wells are at least partially, advantageously fully covered before significant evaporation of the sample inside the wells can take place. Furthermore, in contrast to oil, wax provides a much more stable and reliable barrier.

Advantageously, at the typical temperatures employed during PCR, such as 55-98° C., the wax is not too inviscid such that it would flow inside the wells to an appreciable extent. Rather, the viscosity of the wax is well-adapted such that it covers the wells without filling them. Without wishing to be bound to a theory, it is also believed that the density of the wax contributes to the wax not flowing inside any wells containing sample volume. In some embodiments, the density of the wax is between 0.6 g/cm³ to 0.9 g/cm³, particularly between 0.7 g/cm³ to 0.8 g/cm³.

A further advantage of the wax is that, after completion of the analytical method and reaching room temperature again, the wax rapidly adopts a solid state again. This advantageously ensures that the sample is securely contained inside the wells and covered by the solid cover structure after completion of the analytical method.

A further advantage of the wax is that it is inflammable. It also possesses a suitable heat capacity and heat conductivity which allow the wax to rapidly warm upon exposure to an elevated temperature and to distribute the temperature evenly throughout the solid cover structure. This ensures a uniform melting process and, consequently, uniform covering process of the previously uncovered wells.

The base plate material has a higher melting point than that of the material of which the solid cover structure is made up. In some embodiments, higher, in this context, means at least 30° C. higher, such as at least 100° C., particularly at least 200° C. higher. The base plate material is preferably rigid, i.e. not malleable. Rigid, respectively, not malleable, means that the shape of the material is essentially unchanged upon exposure to an external force of up to 1 N, particularly up to 10 N, e.g. up to 50 N, wherein the force may be applied over 25% of the whole surface area of the base plate material. Essentially unchanged means that the shape of the material does not change by more than 1%, particularly no more than 0.5% of the volume of the material. The base plate may optionally have a thickness of 5 mm-30 mm, particularly 6 mm-10 mm.

In some embodiments, the base plate is heat resistant, i.e. it is resistant to temperatures of up to 600° C., particularly of up to 400° C., particularly of up to 200° C. Resistant means in this context that in particular the structural integrity of the base plate material does not change upon exposure to heat. In particular, the base plate material is solid, i.e. not meltable, at temperatures up to at least 500° C.

The base plate comprises an array of wells. In some embodiments, an array of wells includes at least 1 well, particularly at least 4 wells, more particularly 10 wells. In some embodiments, each well of the array of wells has a volume of 0.00001μ L-100 ML, sin particular 0.01μ L-20μ, particularly 0.03 μL-10μ. In some embodiments, each well as a maximum volume of 1 μL, in particular of maximum 0.1 μL, in particular of maximum 10 nL, in particular of maximum 1 nL.

In some embodiments, the wells are realized as indentations in the base plate. Each well, respectively each indentation may have an open surface area ≤80 mm², such as ≤40 mm², and a depth of 10 micrometer to 10000 micrometer, preferably 20 micrometer to 5000 micrometer, more preferably 50 micrometer to 2000 micrometer. In some embodiments, each well, respectively each indentation, has an open surface area of at least 0.001 mm², particularly at least 0.01 mm².

One advantage of these embodiments is that the wells are conveniently sized to allow standard instrumentation, such as pipettes, to be used to introduce the samples to be analyzed. Additionally, the wells are appropriately sized to provide sufficient volume for a standard sample volume of 2-10 microliters to be accommodated without the risk of splashing during introduction of the sample into the wells. At the same time, the wells are appropriately sized not to be too large such that a large headspace would be created which would aggravate the challenge of partial or complete evaporation of the sample mixture. Further, the wells may be easily produced by drilling corresponding holes of the appropriate size into a metal plate. This advantage applies in particular to those embodiments in which the wells have a depth of approximately 0.6 mm and a diameter of approximately 2 mm, which are particularly well suited for quantitative PCR analysis.

Each well of the array of wells has a well volume and an opening with an opening surface. The sum of the opening surfaces of all wells is defined as the total well opening surface. In a typical embodiment, the total well opening surface may be further sub-divided into a total covered well opening surface and a total uncovered well opening surface. The total covered well opening surface is defined as the sum of the opening surfaces of all covered wells. The total uncovered well opening surface is defined as the sum of the opening surfaces of all uncovered wells.

The top surface of the base plate does not include the opening surfaces of the wells. In other words, the top surface of the base plate relates to the area on the top surface of the base plate which surrounds the wells. In typical embodiments, the top surface of the base plate may be further sub-divided into an uncovered top surface of the base plate and a covered top surface of the base plate. The covered top surface of the base plate is defined as the part of the top surface of the base plate which is covered by the solid cover structure. The uncovered top surface of the base plate is defined as the part of the top surface of the base plate which is uncovered by the solid cover structure.

The outer limits of the effective top surface of the base plate are defined by the outer perimeter of the solid cover structure arranged on the base plate top surface. This means that any fringe areas of the base plate which lie outside the perimeter of the solid cover structure and which therefore are not and cannot be covered by the solid cover structure are typically not included in the effective base plate top surface. In those embodiments including a peripheral frame, the outer limits of the effective base plate top surface are preferably defined by the inner perimeter of the peripheral frame. In other words, the peripheral frame defines the outer limits of the effective base plate top surface but is not itself included in the effective base plate top surface.

In some embodiments, the top surface of the base plate is round, essentially circular or oval. In other embodiments, the top surface of the base plate is rectangular, such as square.

The sum of the top surface of the base plate and the total well opening surface is defined as the total surface of the base plate. In other words, the opening surfaces of the wells are part of the total surface of the base plate. In a typical embodiment, the opening of each well is aligned with the top surface of the base plate.

In some embodiments, 40-100%, in particular 60-90%, of the top surface of the base plate and/or the effective top surface is covered by the solid cover structure. In further embodiments, 60-80% of the total surface of the base plate is covered by the solid cover structure.

In some embodiments, the ratio of the total well opening surface relative to the effective top surface of the base plate is 0.1-0.9, particularly 0.1-0.8. In further embodiments, the ratio of the total uncovered well opening surface relative to the effective top surface of the base plate is 0.1-0.9, particularly 0.2-0.8.

In some embodiments, the ratio of the volume of the solid cover structure relative to the total volume of the array of wells is 0.1-50, particularly 1-30. The total volume of the array of wells corresponds to the sum of the well volumes of all wells of the array of wells. As it is clear to the skilled person, the volume of the well may for example refer to the maximum amount of a liquid that can be filled into a specific well without well overflow.

One advantage of this embodiment is that it strikes a beneficial balance between using as little material as possible to minimize consumption of solid cover structures and potential measurement influences (e.g. optical influences of the molten cover structure on the measurements) on the one hand and ensuring that all wells are covered during the course of performing the analytical method involving thermocycling, particularly PCR, on the other hand.

Each well is configured for receiving a sample, such as a sample to be analyzed, particularly a sample with a sample volume of 0.01 microliters-50 microliters, more particularly 2 microliters-20 microliters.

The solid cover structure is arranged, e.g. directly arranged, on the top surface of the base plate such that at least some of the wells are uncovered, particularly uncovered by the solid cover structure. Directly, in this context, means that the cover structure is in direct contact with the top surface of the base plate. Alternatively, other materials and/or sheets may physically separate the solid cover structure from the top surface of the base plate. In preferred embodiments, such separating materials and/or sheets advantageously possess a high thermal conductivity, particularly a thermal conductivity of at least 0.5 W m⁻¹ K⁻¹. As used herein, at least some of the wells being uncovered means that at least some of the wells are not covered, e.g. accessible for introducing a sample to be analyzed.

The solid cover structure has a thickness which, in some embodiments, is 0.5 mm-5 mm, in particular 1 mm-4 mm. In certain embodiments, the solid cover structure has a solid cover structure top surface and an opposing solid cover structure bottom surface, whose distance defines the solid cover structure thickness and which may preferably have the same surface area. Hereinafter, the solid cover structure thickness is also labelled the thickness of the solid cover structure. In this embodiment, the bottom surface of the solid cover structure is arranged on the base plate top surface such that at least some of the wells are uncovered. In some embodiments, the solid cover structure bottom surface is smaller than the base plate top surface.

In some embodiments, the solid cover structure is arranged such that the uncovered wells are surrounded, particularly circumferentially surrounded, by the solid cover structure. Because the uncovered wells are surrounded by the solid cover structure, the uncovered wells are accessible, e.g. for introducing a sample to be analyzed.

In some specific embodiments in which the uncovered wells are surrounded, particularly circumferentially surrounded, by the solid cover structure, each uncovered well has a maximum distance, i.e. the distance between the solid cover structure and the opening of the corresponding well along the base plate top surface, to the solid cover structure of up to 2 mm, particularly up to 0.5 mm. In some embodiments, the solid cover structure is arranged such that the uncovered wells are directly surrounded by the solid cover structure, i.e. the distance is o. In some embodiments, the solid cover structure is arranged such that the uncovered wells are each individually surrounded, particularly circumferentially surrounded, by the solid cover structure.

In some embodiments, the uncovered wells are grouped into different groups of uncovered wells and the solid cover structure is arranged such that each group of uncovered wells is individually surrounded, particularly circumferentially surrounded, by the solid cover structure. A group of uncovered wells may, for example, comprise 1-20, particularly 2-10 wells, which are together surrounded. A group of uncovered wells preferably only comprises wells that are adjacent to one another.

Circumferentially surrounded means that the entire circumference of a given structure, such as an uncovered well or a group of uncovered wells, is surrounded by the solid cover structure.

The grouping of wells into, for example, a first and a second group may be chosen in accordance with the nature or identity of the samples to be accommodated by the wells of the groups. As an example, samples containing identical or similar sample molecules may be introduced into one group of wells and other samples containing different sample molecules may be introduced into another group of wells. Separating groups of wells containing different sample molecules lowers the risk of cross-contamination. In a specific example, four samples containing different quantities of a first DNA molecule may be introduced into the first group of wells and two samples containing different quantities of a second DNA molecule which is different from the first DNA molecule may be introduced into the second group of wells. The first and second group of wells are advantageously separated from each other. The separation may, for example, be achieved by a lateral distance between the two groups. Additionally, or alternatively, the separation may be achieved by arranging the solid cover structure such as to create a physical barrier between the groups of wells. In the illustrated example, the solid cover structure comprises a rod acting as a physical barrier.

In some embodiments, the solid cover structure is arranged such that the uncovered wells are only partly surrounded by the solid cover structure. As an example of being only partly surrounded, the part of the solid cover structure surrounding a given uncovered well (respectively group of uncovered wells) may have the shape of a circular segment, particularly of a semi-circle, which surrounds only half of the circumference of the uncovered well (respectively group of uncovered wells).

In some embodiments, the solid cover structure has a shape defining at least one gap, such as a plurality of through-holes, cut-outs or sectional openings. Typically, as understood herein, the at least one gap, such as the plurality of through-holes, is not included in the solid cover structure. It follows that the volume and the top or bottom surface of the solid cover structure do not include either the volume or the surface of the at least one gap.

The at least one gap defined by the shape of the solid cover structure may typically extend through the entire solid cover structure thickness. Each through-hole of the plurality of through-holes (respectively cut-out of the plurality of cut-outs or sectional opening of the plurality of sectional openings) may also extend through the entire solid cover structure thickness. A gap and a through-hole (respectively cut-out or sectional opening), as used herein, need not be round or circular but instead may have various shapes. As an example, they may have different cross sectional areas, such as a circular cross-sectional area or a polygonic cross-sectional area. In some embodiments, the through-holes (respectively cut-outs or sectional openings) may coincide with either the uncovered wells or the groups of uncovered wells.

The at least one gap defined by the solid cover structure needs not be fully surrounded by the solid cover structure. As an example, the solid cover structure may be x-shaped and thus define four gaps, i.e. cutouts, each of which are only surrounded by two flanks of the solid cover structure.

A through-hole, by contrast, is typically fully surrounded by the solid cover structure.

In some embodiments, each through-hole has an open surface area of 1 mm²-400 mm², particularly 1 mm²-100 mm².

In a further embodiment, the solid cover structure has a shape defining a perforation with a plurality of holes, wherein preferably the holes of the perforation coincide with the uncovered wells.

In some embodiments, the shape of the solid cover structure includes at least two rods which are connected with each other. In some embodiments, the shape of the solid cover structure is x-shaped, y-shaped or z-shaped. In some embodiments, the solid cover structure is a grid-structure.

In some embodiments, the solid cover structure has a shape defining at least one opening.

In some embodiments, the solid cover structure, e.g. the shape of the solid cover structure, comprises a peripheral circumferential edge structure and at least one connecting rod within the peripheral circumferential edge structure. Each connecting rod within the peripheral circumferential edge structure may particularly be connected, preferably directly connected, to the peripheral circumferential edge structure.

In a typical embodiment, the peripheral circumferential edge structure fully surrounds the array of wells.

This ensures that the solid cover structure, once molten, flows towards the array of wells from all possible lateral sides of the array of wells. In other words, the lateral flow of the solid cover structure in its molten state forms a flow frontier that approaches the wells from all possible lateral directions, i.e. from the entire perimeter of the array of wells. The perimeter of the array of wells need not be circular but may also be, among other shapes, polygonal, such as rectangular.

In some embodiments, the connecting rod is positioned such that it separates at least two different groups of wells, thus creating a physical barrier between the at least two different groups which, among other things, decreases the risk of cross-contaminations. It also enables the user to keep a better overview of the different wells, especially in embodiments comprising more than 2 wells. The connecting rod may optionally have a thickness that is different from, particularly inferior to the thickness of the peripheral circumferential edge structure.

One advantage of having at least one connecting rod is that the rod provides an additional flow frontier of molten solid cover material, which translates into a shorter time required for all previously uncovered wells to be overflown and thus covered by solid cover material. It also leads to a more evenly distributed covering process for the differently positioned wells. In other words, by having at least one connecting rod, different wells with different positions are covered by the solid cover structure in its molten state with a similar speed and at similar points in time. In still other words, by having at least one connecting rod, the previously uncovered wells have a more similar distance to the solid cover material. This means that the solid cover material, in its molten state, reaches each uncovered well at a similar point in time and overflows each uncovered well with a similar speed. Consequently, the degree of evaporation is similarly small for all different wells, which leads to more homogeneous and faithful analytical results.

In some embodiments, the at least one gap is configured such that each uncovered well has a maximum distance to the solid cover structure of 0.1 mm-20 mm, particularly 0.5 mm-5 mm. In some embodiments, the at least one gap is sized and shaped such that each uncovered well has a maximum distance to the solid cover structure of 0.1 mm-20 mm, particularly 0.5 mm-5 mm.

In some embodiments, the solid cover structure is translucent at 40° C.-99° C., particularly translucent to wavelengths of 380 nm-750 nm, such as 400 nm-700 nm, particularly 440 nm-650 nm. Translucent, as defined herein, relates primarily to transmission, i.e. to the fraction of incident light that is transmitted through the solid cover structure. The solid cover structure is translucent if this fraction is at least 20%, particularly at least 40%, at least for light in the UV/Vis-range, particularly in the range of 400 nm-700 nm.

The translucency may additionally relate to the bidirectional transmittance distribution function and/or the bidirectional reflectance distribution function. The bidirectional transmittance distribution function, as used herein, relates to the angle(s) of incident light as well as the angle(s) of the transmitted light. The bidirectional reflectance distribution function, as used herein, relates to the light which is reflected back from the translucent material to the origin of incident light.

In some embodiments, the base plate is made of a material with a thermal conductivity of 10 W/(m*K)-300-W/(m*K), particularly 100 W/(m*K)-280 W/(m*K).

In some embodiments, the base plate is made of metal. In some embodiments, the base plate is made of a metal comprising any one of aluminum, steel, copper, gold, silver, titanium, nickel, lead, zinc, or any alloy comprising any one of these metals. In particular, the base plate may be made of aluminum.

The choice of this base plate material has the advantage of having a high thermal conductivity, which allows the user to rapidly apply different temperatures and thus employ short thermocycles with high temperature differences. This ultimately translates into high turnover and a high number of PCR cycles that may be run per minute. In some embodiments, the top surface of the base plate is plane and smooth, which serves to enlarge the contact surface with the solid cover structure and thus allows for efficient heat transfer from the base plate to the solid cover structure.

In some embodiments, each uncovered well has a maximum distance of 0.1 mm-20 mm, in particular 0.5 mm-10 mm from the solid cover structure. The maximum distance from the solid cover structure to an uncovered well denotes the closest lateral distance from any point of the solid cover structure to the outer edge of the opening of the respective uncovered well. The lateral orientation is defined by two axes that are parallel to the base plate top surface. In other words, the base plate top surface defines the lateral orientation.

In some embodiments, the sample holder further comprises a peripheral frame, particularly a peripheral circumferential frame, encompassing, in particular completely encompassing, the solid cover structure, wherein the peripheral frame is made of a material with a melting point which is higher than the melting point of the solid cover structure.

The material of the peripheral frame, particularly the peripheral circumferential frame, is preferably chosen such that its melting point is higher than the highest temperature that may be set during the corresponding method involving thermocycling, particularly higher than the highest temperature that may be set during PCR analysis. As an example, for PCR analysis involving thermocycling between 38° C. and 99° C., the material of the peripheral frame is preferably chosen such that its melting point is higher than 99° C.

The peripheral frame typically has a shape that is complementary to that of the solid cover structure, such that it circumferentially encompasses the solid cover structure. The peripheral frame may either be protruding from the base plate top surface or the base plate comprises a depression, i.e. a cavity, with a circumferential wall forming the peripheral frame. In the latter embodiments, the depression, respectively cavity, comprises both the array of wells and the solid cover structure.

Typically, the peripheral frame encompasses at least one well, particularly a plurality of wells, in particular all wells. In other words, at least one well, particularly a plurality of wells, in particular all wells, of the array of wells-regardless if covered or uncovered by the solid cover structure—is (respectively are) surrounded, i.e. completely surrounded, by the peripheral frame. In some embodiments, the peripheral frame is in direct contact with the solid cover structure in the solid state. The peripheral frame may, for example, have a circular or polygonal contour. The peripheral frame is preferably arranged such that its height is the same as or exceeds the solid cover structure thickness. As an example, the peripheral frame may have a height that is at least as large as the solid cover structure thickness. This ensures that the solid cover structure, in the molten state, does not flow over the peripheral circumferential frame.

The peripheral frame is made of a material with a melting point that is higher than that of the material of which the solid cover structure is made up, such as at least 20° C. higher, particularly at least 50° C. higher. In some embodiments, the peripheral frame is made of a metal or a polymer, such as any one or any combination of the following: polypropylene, polyethylene terephthalate, polyethylene, polyvinyl chloride, polypropylene, polystyrene, polylactic acid, polycarbonate, polymethyl(meth)acrylate or polytetrafluoroethylene. In a preferred embodiment, the peripheral frame is made of polypropylene. The peripheral frame, particularly the peripheral circumferential frame, provides an outer limit for the solid cover structure when it is in the molten state, and thus serves to direct its lateral flow movement. The peripheral frame may also be made from the same material as the base plate. In particular, the peripheral frame may in some embodiments be an integral part of the base plate, or alternatively it may be a separate element.

The indicated melting point of the peripheral frame ensures that the peripheral circumferential frame does not melt and is able to provide an outer limit for the solid cover structure when the solid cover structure is in the molten state. Accordingly, the peripheral circumferential frame serves to direct the lateral flow movement of the solid cover structure in its molten state. In particular, it prevents the solid cover structure to flow off the top surface of the base plate and ensures that it instead flows towards and eventually over and above the previously uncovered wells during the course of performing the analytical method.

The peripheral circumferential frame may be circular, e.g. with a diameter of 10 mm-100 mm, or may alternatively be polygonal, among other possible shapes.

The general objective is achieved in a second aspect of the invention by a method for manufacturing a sample holder, in particular a sample holder as described herein, the method comprising the steps of:
Providing a base plate, wherein the base plate is made of a base plate material and comprises a top surface, wherein the base plate comprises an array of wells, wherein each well is configured for receiving a sample;
Providing a solid cover structure being made of a material having a melting point which is lower than the melting point of the base plate material;
arranging the solid cover structure on the top surface of the base plate such that at least some of the wells are uncovered to form the sample holder.

In some embodiments, the step of providing a solid cover structure comprises the steps of:
Providing a sheet element made of a sheet material having a melting point which is lower than the melting point of the base plate material;
generating at least one through-hole through the sheet element to generate the solid cover structure.

The sheet element is a three-dimensional structure which has a sheet element top surface and a sheet element bottom surface and a sheet element thickness defined as the distance between the sheet element top surface and the sheet element bottom surface. The sheet element thickness is preferably 0.1 mm-10 mm, such as 0.5 mm-8 mm. Typically, the sheet element is flat. Flat means that the square root of the flat sheet element top surface and the flat sheet element bottom surface is at least 2 times, particularly at least 8 times, as big as the flat sheet element thickness.

In some embodiments, the sheet element has a rounded shape, in particular circular or oval shape, i.e. the top and/or the bottom surface of the sheet element is round, respectively circular or oval. In other embodiments, the sheet element has a polygonal shape.

In some embodiments, the step of generating at least one through-hole through the sheet element involves punching, embossing, cutting, needling or the like.

The general objective is achieved in a third aspect of the invention by an apparatus for performing an analytical method involving thermocycling, such as polymerase chain reaction, comprising:
the sample holder as disclosed herein, in particular according to any of the embodiments described in the first aspect,
a thermal setting element (3) thermally coupleable to the sample holder, in particular to the base plate of the sample holder, and a controller for controlling a thermal cycle of the thermal setting element.

The thermal setting element is adapted to be coupleable, i.e. connectable, to the sample holder for controlling the temperature of the sample holder, e.g. if the sample holder is mounted to the apparatus. If the thermal setting element is coupled to the sample holder, it heats or cools down the sample holder. It can therefore be defined as a “heating and/or cooling element”. The thermal setting element can work in the range of 10-120° C., preferably it works in the range of 40-100° C.

The thermal setting element can comprise a stage for mounting the sample holder. In particular, such a stage could comprise an attachment element, e.g. a clip, to fix the sample holder to the stage, such that good thermal transport is achieved between the sample holder and the thermal setting element, respectively its stage.

Preferably, the thermal setting element is a Peltier thermoelectric device. Such a Peltier device can be constructed of pellets of n-type and p-type semiconductor material that are alternately placed in parallel to each other and are electrically connected in series. Examples of semiconductor materials that can be utilized to form the pellets in a Peltier device, include but are not limited to, bismuth telluride, lead telluride, bismuth selenium and silicon germanium. However, it should be appreciated that the pellets can be formed from any semiconductor material as long as the resulting Peltier device exhibits thermoelectric heating and cooling properties when a current is run through the Peltier device. In various embodiments, the interconnections between the pellets can be made with copper which can be bonded to a substrate.

In a preferred embodiment, the thermal interference conductance between the thermal setting element and the sample holder is therefore at least 1000 W/(m² K), preferably at least 4000 W/(m² K), very preferably at least 8000 W/(m² K).

The apparatus further comprises a controller, for controlling a thermocycle of the thermal setting element. In respect of the apparatus, the controller is adapted to control the thermal setting element, such that the thermal setting element heats up or cools down the sample holder to a temperature commanded by the controller.

Preferably, the thermal setting element heats the sample holder with a net effective heating ramp equal or higher than 5.0° C./s (net effective heating ramp ≥5.0° C./s), preferably with a net effective heating ramp equal or higher than 8.0° C./s (net effective heating ramp ≥8.0° C./s), or very preferably with a net effective heating ramp equal or higher than 10.0° C./s (net effective heating ramp ≥10.0° C./s).

Preferably, the thermal setting element cools down the sample holder with a net effective cooling ramp equal or lower than −5.0° C./s (net effective cooling ramp≤−5.0° C./s), preferably with a net effective cooling ramp equal or lower than −8.0° C./s (net effective cooling ramp≤−8.0° C./s), or very preferably with a net effective cooling ramp equal or lower than −10.0° C./s (net effective cooling ramp≤−10.0° C./s). The heating or cooling procedure of the thermal element is preferably controlled by the controller.

In some embodiments, the apparatus further comprises an optical detector arranged such that optical detection of the sample inside the reaction wells of the sample holder is possible, wherein the optical detector is configured to detect at least one optical signal from one sample within one well of the base plate.

Optical detection of the sample inside the wells of the sample holder is possible if every single reaction well containing a sample is accessible for incident light deriving from the optical detector. In some embodiments, the optical detector is arranged in line of sight of the reaction wells of the sample holder. The arrangement in line of sight of the array of wells of the sample holder means that the optical detector can receive optical signals from the wells, if the sample holder is mounted to the apparatus. In some embodiments, the detector is arranged directly above the sample holder, wherein the detection area of the detector and the surface of the sample holder are aligned in parallel. Preferably, the optical detector is a color charge-coupled device (CCD) or a complementary metal-oxide-semiconductor (CMOS) type camera which is focused on the sample holder for simultaneous detection of several targets.

The optical detector is typically configured to detect at least one optical signal, in particular a fluorescent or a chemiluminescent signal, from one sample volume of one well of the sample holder.

In some embodiments, the apparatus further comprises an excitation light source. The excitation light source is preferably arranged such that the samples inside the reaction wells of the sample holder are accessible for the light beam emitted from the excitation light source.

The general objective is achieved in a fourth aspect of the invention by use of the sample holder as disclosed herein for the polymerase chain reaction analysis of a sample, in particular in the apparatus as disclosed herein.

The highest temperature applied during the polymerase chain reaction analysis is higher, preferably at least 5° C. higher, particularly at least 10° C. higher, than the melting point of the solid cover structure. In some embodiments, the lowest temperature applied during the polymerase chain reaction analysis is higher, preferably at least 5° C. higher, particularly at least 10° C. higher, than the melting point of the solid cover structure. However, in some embodiments, the lowest temperature applied during the polymerase chain reaction analysis is may also be lower than the melting point of the solid cover structure. In some embodiments, the average value of the highest and the lowest temperature applied during the polymerase chain reaction analysis is higher, preferably at least 5° C. higher, particularly at least 10° C. higher, than the melting point of the solid cover structure. As the skilled person understands, the temperature applied during the polymerase chain reaction refers specifically to the temperature applied during thermocycling, which is typically between 40° C. and 99° C., and does not include any additional periods for sample preparation of final cooling of the sample after completion of the polymerase chain reactions.

As outlined above, an analytical method involving thermocycling is an analytical method during which at least two different temperatures T1 and T2 for at least two different time periods are applied. In some embodiments, the sample to be analyzed and/or the sample holder is exposed to the at least two different temperatures T1 and T2. As an example, the analytical method may involve consecutively setting temperature T1 for a first period p1, following by setting temperature T2 for a second period p2, followed again by T1 for the period p1, followed again by T2 for the period p2, and so on. In some embodiments, the sample holder for use in an analytical method involving thermocycling is a sample holder for use in polymerase chain reaction.

### BRIEF DESCRIPTION OF THE DRAWINGS

The terms Fig., Figs., Figure, and Figures are used interchangeably in the specification to refer to the corresponding figures in the drawings.

The present disclosure will be more fully understood from the detailed description given below and the accompanying drawings, which should not be considered limiting to the invention described in the appended claims. The drawings show:

FIG. 1 shows one embodiment of a sample holder as disclosed herein in solid state;

FIG. 2 shows a cross-sectional view of the embodiment of the sample holder shown in FIG. 1 in solid state;

FIG. 3 shows a cross-sectional view of the embodiment of the sample holder shown in FIG. 1 in molten state;

FIG. 4 shows an embodiment of an apparatus for performing an analytical method involving thermocycling;

FIG. 5 shows the signal measured in each cycle of a PCR experiment using only the base plate as disclosed herein but not using the solid cover structure;

FIG. 6 shows the signal measured in each cycle of a PCR experiment using an embodiment of the sample holder disclosed herein, including the solid cover structure; the PCR experiment was run under otherwise identical conditions to those employed in the experiment of FIG. 4.

### DESCRIPTION OF THE INVENTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein.

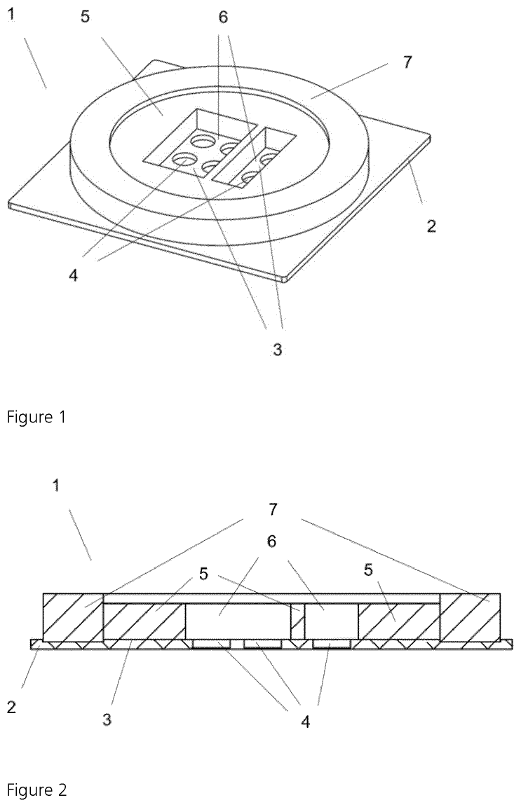

FIG. 1 shows an embodiment of a sample holder as disclosed herein. It is in its solid state. In other words, the sample holder is shown in its state prior to the start of the analytical method involving thermocycling. The sample holder is in particular suitable for use in polymerase chain reaction (PCR) analyses. It includes a base plate 2 and a solid cover structure 5. The base plate 2 comprises a top surface 3. In the illustrated embodiment, the solid cover structure 5 is arranged directly on the top surface 3 of the base plate 2. Directly, in this example, means that the solid cover structure 5 is in direct contact with the top surface 3 of the base plate 2.

In the illustrated embodiment, the base plate 2 is made of aluminum and comprises an array of wells 4. In the illustrated embodiment, it comprises a total of six wells, which are grouped into a first group of wells comprising four wells and a second group comprising two wells. In the illustrated embodiment, the wells 4 are realized as indentations with a circular cross section. The diameter is 3 mm and the depth is 0.6 mm. Each well 4 has one opening which, in the illustrated embodiment, is flush with the top surface 3 of the base plate 2.

In the illustrated embodiment, the solid cover structure is made of wax. The melting point of this wax is 42° C.

The sample holder 1 illustrated in FIG. 1 further comprises a peripheral circumferential frame 7. In the illustrated embodiment, the peripheral circumferential frame 7 is in direct contact with the solid cover structure in its solid state and is made of polypropylene, which has a melting point significantly higher than that typically employed during PCR analysis. In the illustrated embodiment, the peripheral circumferential frame fully surrounds the solid cover structure and has a height of 4 mm.

In the illustrated embodiment, the solid cover structure further comprises a peripheral circumferential edge structure and one connecting rod with two ends connected to the peripheral circumferential edge structure. The connecting rod has a width of 1 mm and is positioned such that it separates the first group of wells from the second group of wells and thus creates a physical barrier between the two. The connecting rod and the peripheral circumferential edge structure have a thickness of 3 mm.

In the illustrated embodiment, the solid cover structure 5 has a thickness of 3 mm, wherein the thickness is perpendicular to the top surface 3 of the base plate 2. The volume of the solid cover structure 5 in the illustrated embodiment is 1263 mm³.

FIG. 2 shows a cross-sectional view of the embodiment of the sample holder shown in FIG. 1 in solid state, i.e. before performing the analytical method. All specifications previously made with respect to FIG. 1 similarly apply to FIG. 2 as well.

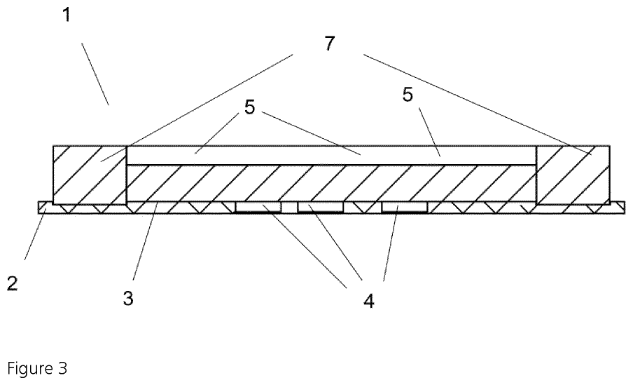

FIG. 3 shows a cross-sectional view of the embodiment of the sample holder shown in FIG. 1 in molten state. All specifications previously made with respect to FIG. 1 similarly apply to FIG. 2 as well, except that the solid cover structure now covers all wells 4 previously uncovered.

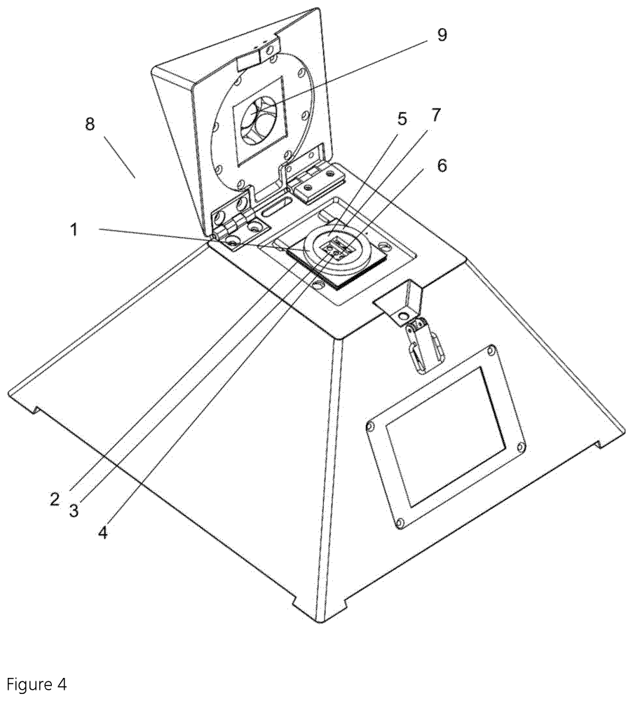

FIG. 4 shows a perspective view of an embodiment of an apparatus 8. The apparatus 8 comprises a sample holder 1 and a thermal setting element. The sample holder 1 is mounted to the thermal setting element, in particular to a stage of the thermal setting element. The thermal setting element is in thermal connection to the sample holder 1 for heating or cooling the sample holder 1 and the sample volumes respectively.

The apparatus 8 also comprises a housing which, in the illustrated embodiment, is pyramidal. This shape of the body is advantageous, since it has a bigger surface for a given machine volume and therefore its functionality as a heat sink is very efficient. The sample holder 1 is preferably thermally coupled to the housing, which enables the housing to serve as a thermal heat sink for enabling fast change of temperature of the sample holder 1.

The housing houses a controller for controlling a thermal cycle of the thermal setting element. The housing further houses an optical detector 9, which is arranged within a peak section of the pyramidal housing. Light sources may also be arranged within this peak section.

Preferably, the apparatus 8 has the dimensions of 8 cm×8 cm×17 cm. Preferably, the apparatus 8 weighs below 1 kg, particularly 500 g.

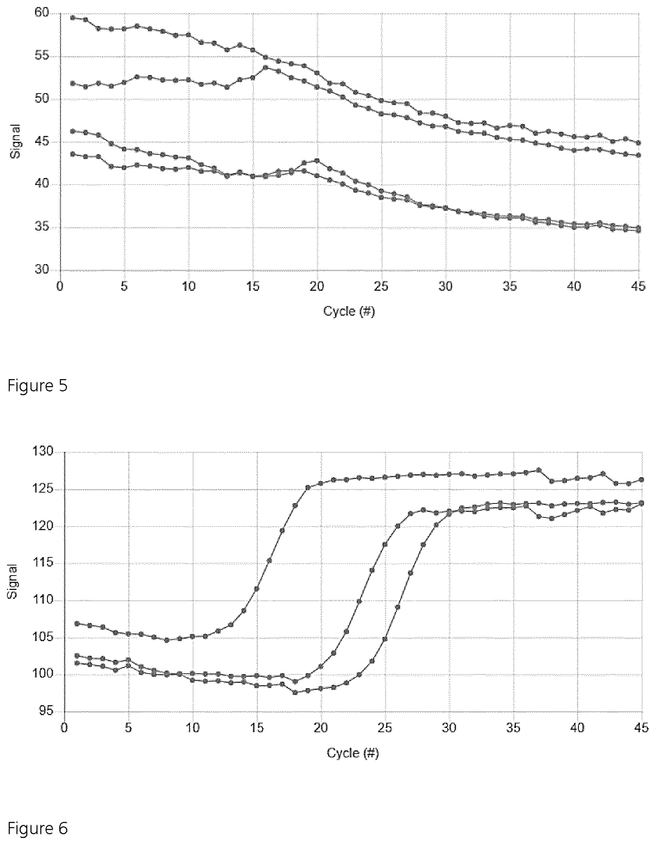

FIG. 5 shows the signal measured in the first 45 cycles of a PCR experiment using only the base plate as disclosed herein but not using the solid cover structure. No cover is used. No other measure to prevent evaporation is employed, such as the use of a mineral oil layer. The signal refers to a fluorescent assay. The signal is captured with a CCD sensor and has arbitrary units (as it depends on the settings of the system). The four different lines correspond to samples in four different wells of the base plate.

The PCR experiment involved analyzing a sample volume comprising:

•Mastermix:
KAPA SYBR FAST qPCR Master Mix (2X), which contains KAPA SYBR FAST DNA Polymerase,
reaction buffer, dNTPs, SYBR Green I dye, and MgC12 at a final concentration of 2.5 mM
•A forward primer:
AGA CGT GTG CTC TTC CGA TC
•A reverse primer:
ACA CGA CGC TCT TCC GAT CT
•Synthetic DNA:
Sequence {5′-3′):
ACA CGA CGC TCT TCC GAT CTG ACT CTC ATC TAC TAG ATA GAT CTC CAC CTC
GCA GTC TCG TCT TCA ACG GTG
CTC ACG CGA TAT AGT TAG CTC GCG ACT ACC ATA GCG CTA CAT
AGA AGT CAG CAA GAG ATC GGA AGA GCA CAC GTC T
Sequence (5′-3′):
AGA CGT GTG CTC TTC CGA TCT CTT GCT GAC TTC TAT GTA GCG CTA TGG TAG TCG
CGA GCT AAC TAT ATC GCG
TGA GCA CCG TTG AAG ACG AGA CTG CGA GGT GGA GAT CTA TCT
AGT AGA TGA GAG TCA GAT CGG AAG AGC GTC GTG T
•A solution of bovine serum albumin
•Deionized water

A sample volume smaller than 4 μL has been applied onto the sample holder according to FIG. 1. The sample holder has been placed under the optical detector and the excitation light source of the device.

The excitation light source is composed of 8 commercial LEDs with a power rating of 3 W and a central wavelength of 460 nm. The light sources were directed to the sample holder for exciting the sample volumes captured in the wells of the sample holder.

Detection was performed with a single-board computer (Raspberry Pi model 3B) equipped with a CCD camera (Raspberry Pi Camera Module v2) that was placed vertically above the center of the sample holder. A 12 mm lens was mounted onto the CCD camera and a long pass filter was placed in front of the lens (cut on frequency approximately at 580 nm). The signal was detected by recording the image produced by the CCD camera and saving it to an image file.

Without wishing to be bound to a theory, the decrease in signal over time may be attributed to evaporation of the sample.

FIG. 6 shows the signal measured in each cycle of a PCR experiment using an embodiment of the sample holder disclosed herein, including the solid cover structure described in further details in FIGS. 1-3. The PCR experiment was performed under otherwise identical conditions to those employed in the experiment of FIG. 5, the only difference being the use of the solid cover structure. The three different lines shown in FIG. 6 correspond to samples in three different wells of the base plate. All three wells were uncovered prior to the PCR analysis.

The vast discrepancy between FIGS. 5 and 6 demonstrate that the solid cover structure improves the measurement of the PCR analysis. Without wishing to be bound to a theory, this may be attributed mainly to the prevention of evaporation of sample from the wells.

1. A sample holder for use in an analytical method involving thermocycling, wherein the sample holder comprises:
a. a base plate, wherein the base plate is made of a base plate material and comprises a top surface, wherein the base plate comprises an array of wells, wherein each well is configured for receiving a sample; and
b. a solid cover structure being made of a material having a melting point which is lower than the melting point of the base plate material; wherein the solid cover structure is arranged on the top surface of the base plate such that at least some of the wells are uncovered.

2. The sample holder according to claim 1, wherein the melting point of the solid cover structure (5) is between 38° C.-55° C.

3. The sample holder according to claim 1, wherein the solid cover structure is made of wax.

4. The sample holder according to claim 1, wherein 40%-100% of the top surface of the base plate and/or of an effective top surface of the base plate is covered by the solid cover structure.

5. The samples holder according to claim 1, wherein the ratio of the total well opening surface relative to the effective top surface of the base plate is 0.1-0.9.

6. The sample holder according to claim 1, wherein the ratio of the volume of the solid cover structure relative to the total volume of the array of wells is 0.1.

7. The sample holder according to claim 1, wherein the solid cover structure cover has a thickness of 0.5 mm.

8. The sample holder according to claim 1, wherein the solid cover structure is arranged such that the uncovered wells are surrounded by the solid cover structure.

9. The sample holder according to claim 1, wherein the solid cover structure has a shape defining at least one gap, cut-out or sectional opening.

10. The sample holder according to claim 8, wherein each through-hole has an open surface area of 1 mm²-400 mm².

11. The sample holder according claim 8, wherein the solid cover structure comprises a peripheral circumferential edge structure and at least one connecting rod within the peripheral circumferential edge structure.

12. The sample holder according to claim 8, wherein the at least one gap is configured such that each uncovered well has a maximum distance to the solid cover structure of 0.1 mm-20 mm.

13. The sample holder according to claim 1, wherein the solid cover structure is translucent at 40° C.99° C.

14. The sample holder according to claim 1, wherein the base plate is made of a material with a thermal conductivity of 10 W/(m*K)-300 W/(m*K).

15. The sample holder according to claim 1, wherein the base plate is made of metal.

16. The sample holder according to claim 1, wherein each uncovered well has a maximum distance of 0.1 mm-20 mm from the solid cover structure.

17. The sample holder according to claim 1, further comprising a peripheral frame encompassing the solid cover structure, wherein the peripheral frame is made of a material with a melting point which is higher than the melting point of the solid cover structure.

18. A method for manufacturing a sample holder, in particular a sample holder according to claim 1, the method comprising the steps of:
providing a base plate, wherein the base plate is made of a base plate material and comprises a top surface, wherein the base plate comprises an array of wells, wherein each well is configured for receiving a sample;
providing a solid cover structure being made of a material having a melting point which is lower than the melting point of the base plate material; and
arranging the solid cover structure on the top surface of the base plate such that at least some of the wells are uncovered to form the sample holder.

19. The method according to claim 18, wherein the step of providing the solid cover structure comprises the steps of:
providing a sheet element made of a sheet material having a melting point which is lower than the melting point of the base plate material; and
generating at least one through-hole through the sheet element to generate the solid cover structure.

20. An apparatus for performing an analytical method involving thermocycling comprising:
the sample holder according to claim 1,
a thermal setting element thermally coupleable to the sample holder, and
a controller for controlling a thermal cycle of the thermal setting element.

21. An apparatus according to claim 20, further comprising an optical detector arranged such that optical detection of the sample within the reaction wells of the sample holder is possible, wherein the optical detector is configured to detect at least one optical signal from one sample within one well of the base plate.

22. An apparatus according to claim 20, further comprising an excitation light source.

23. A method for polymerase chain reaction analysis of a sample, comprising:
providing an apparatus for performing an analytical method involving thermocycling comprising:
the sample holder according to claim 1,
a thermal setting element thermally coupleable to the sample holder, and
a controller for controlling a thermal cycle of the thermal setting element;
inserting a sample into a corresponding well of the sample holder; and
analyzing the sample.


SEQUENCE LISTING (4 sequences)

SEQ ID NO: 1 - DNA, 20 bp, synthetic construct
  misc_feature 1..20: note = forward primer
  source 1..20: mol_type = other DNA
agacgtgtgctcttccgatc

SEQ ID NO: 2 - DNA, 20 bp, synthetic construct
  misc_feature 1..20: note = reverse primer
  source 1..20: mol_type = other DNA
acacgacgctcttccgatct

SEQ ID NO: 3 - DNA, 148 bp, synthetic construct
  misc_feature 1..148: note = Sequence (5' - 3')
  source 1..148: mol_type = other DNA
acacgacgctcttccgatctgactctcatctactagatagatctccacctcgcagtctcgtcttcaacggtgctcacgcgatatagttagctcgcgactaccatagcgctacatagaagtcagcaagagatcggaagagcacacgtct

SEQ ID NO: 4 - DNA, 148 bp, synthetic construct
  misc_feature 1..148: note = Sequence (5' - 3')
  source 1..148: mol_type = other DNA
agacgtgtgctcttccgatctcttgctgacttctatgtagcgctatggtagtcgcgagctaactatatcgcgtgagcaccgttgaagacgagactgcgaggtggagatctatctagtagatgagagtcagatcggaagagcgtcgtgt